(19) United States
(12) Patent Application Publication
(10) Pub. No.: US 2006/0070941 A1
(43) Pub. Date: Apr. 6, 2006

(54) In-tank fuel module

(75) Inventors: L. Steven Cline, Fayetteville, NC (US); Rajan Ahuja, Fayetteville, NC (US)

Correspondence Address: CARLSON, GASKEY & OLDS, P.C., 400 WEST MAPLE ROAD, SUITE 350, BIRMINGHAM, MI, 48009, US

(73) Assignee: Arvin Technologies, Inc.

(21) Appl. No.: 10/958,773

(22) Filed: Oct. 5, 2004

(51) Int. Cl. B01D 24/00; F02M 37/04; B01D 47/02

(52) U.S. Cl. 210/416.4; 137/565.22; 123/509

(57) ABSTRACT

A fuel module includes a fuel pump having a fuel inlet and fuel outlet. The module also includes a fuel filter having a filter inlet and a filter outlet. The module has a housing with a body that defines a cavity. The fuel pump and fuel filter are arranged in the cavity. The housing includes a removable end cap that at least partially encloses the cavity in an installed position and provides access to the cavity in a service position. Fastening elements such as threaded fasteners secure the removable end cap to the body in the installed position. Seals are arranged between the fuel pump and fuel filter and the end cap when in the installed position. The end cap also includes caps secured to a surface of the end cap to provide fluid passages where necessary. When the fuel pump or fuel filter requires replacement, the threaded fasteners and end cap are removed from the body, and the fuel pump and/or fuel filter may be detached from the end cap.

### BACKGROUND OF THE INVENTION

This invention relates to an in-tank fuel module for a vehicle fuel tank.

An increasing trend in the automobile industry is to provide modules that are a preassembly of multiple components for installation into a vehicle assembly or subassembly as a unit. To this end, in-tank fuel modules have become increasingly more prevalent in vehicles. The fuel modules may include a fuel pump, filter and other devices in a typically complicated single unit.

Prior art in-tank fuel modules provide modularity while greatly sacrificing the ability to change out failed components within the module. For example, a fuel module housing may include one or more portions that are permanently secured to one another encapsulating components that may need to be changed during the service life of the vehicle. Thus, a failed fuel pump or filter must require replacement of the entire fuel module at a great cost to the vehicle manufacturer or vehicle owner. Therefore, what is needed is an improved in-tank fuel module providing an assembly having the fuel pump and filter while providing the ability to disassemble the fuel module to the degree necessary to change out a failed component.

### SUMMARY OF THE INVENTION AND ADVANTAGES

The present invention provides a fuel module including a fuel pump having a fuel inlet and fuel outlet. The fuel module also includes a fuel filter having a filter inlet and a filter outlet. The fuel module has a housing with a body that defines a cavity. The fuel pump and filter are arranged in the cavity. The housing includes a removable end cap that at least partially encloses the cavity in an installed position and provides access to the cavity in a service position. Fastening elements such as threaded fasteners secure the removable end cap to the body in the installed position.

In one example of the embodiment, the end cap includes portions for receiving the fuel outlet and the filter inlet and outlet. Seals are arranged between the end cap and each of the fuel outlet and filter inlet and outlet when in the installed position. The end cap also includes caps secured to a surface of the end cap to provide fluid passages where necessary.

When the fuel pump or filter requires replacement, the fasteners and end cap are removed from the body, and the fuel pump and/or filter may be detached from the end cap at the seals.

Accordingly, the above invention provides an improved in-tank fuel module providing an assembly having the fuel pump and filter while providing the ability to disassemble the fuel module to the degree necessary to change out a failed component.

### BRIEF DESCRIPTION OF THE DRAWINGS

Other advantages of the present invention can be understood by reference to the following detailed description when considered in connection with the accompanying drawings wherein:

FIG. 1 is a perspective view of a fuel tank having the inventive in-tank fuel module.

FIG. 2 is a side perspective view of the inventive fuel module housing body.

FIG. 3 is an exploded perspective view of the inventive fuel module.

FIG. 4 is a perspective view of the fuel module with the end cap and caps installed on the end cap.

FIG. 5 is a cross-sectional view of the inventive fuel module.

FIG. 6 is a perspective view of one of the end caps including a fuel return.

FIG. 7 is a perspective view of the inventive fuel return valve assembly.

FIG. 8 is a top perspective view of the fuel module.

### DETAILED DESCRIPTION OF THE PREFERRED EMBODIMENT

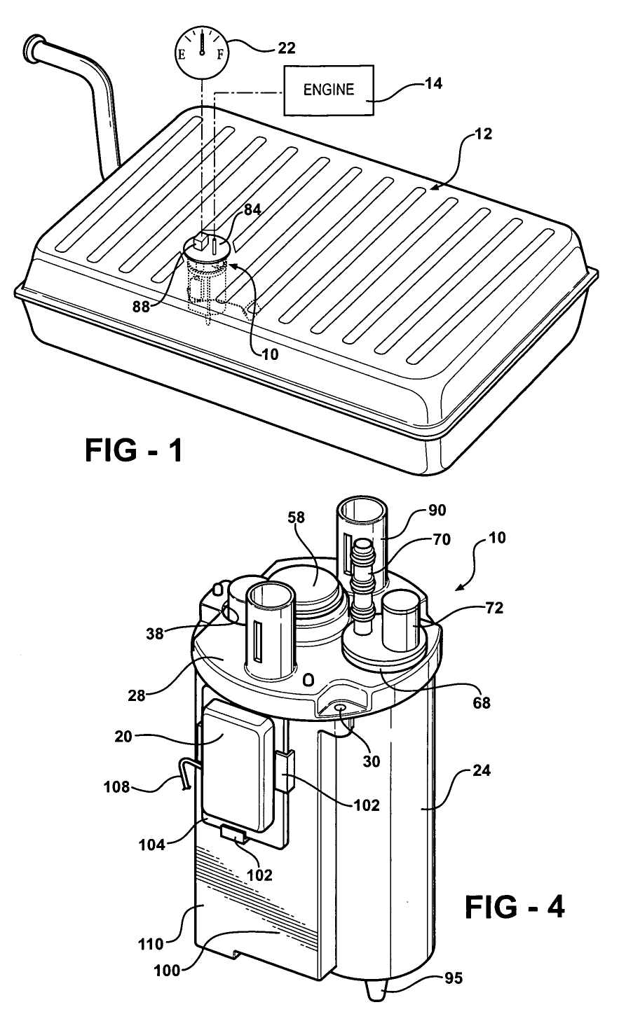

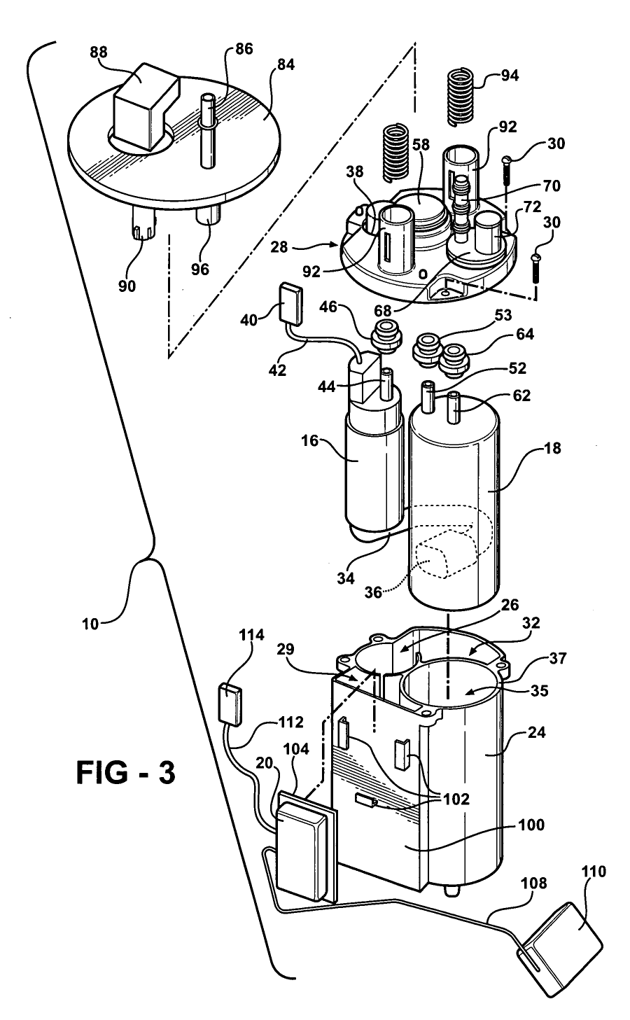

An in-tank fuel module 10 is shown in FIG. 1 within a fuel tank 12. The module 10 includes a fuel pump 16, filter 18, and fuel level sender 20, which is best shown in FIG. 3. With continuing reference to FIG. 1, the module 10 provides fuel to an engine 14 and is electrically connected to a fuel gauge 22, battery, and other devices.

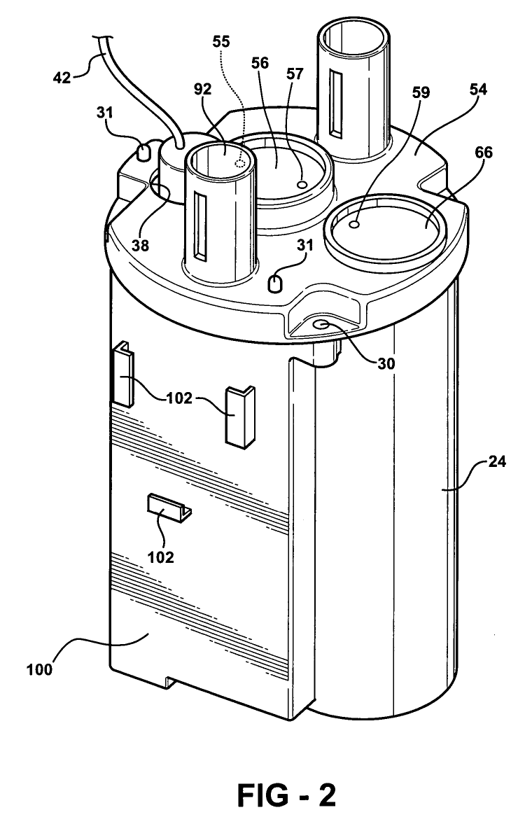

Referring to FIG. 2 and 3, the module 10 includes a housing 24 that may be constructed from several components permanently and/or removably secured to one another. The housing 24 includes a body defining a cavity receiving the fuel pump 16 and filter 18. The housing 24 also includes an end cap 28 removably secured to the body by, for example, fasteners 30 extending through openings (or shown bolts). Locators 31 are used to position the end cap 28 relative to the body. Alternatively, the end cap 28 may be snap-fit onto the body of the housing 24. Although the inventive end cap 28 is shown secured to the top of the housing 24, it should be understood that the end cap 28 may be secured in any other suitable location and by any other suitable means. For example, the end cap 28 may be secured to the bottom of the housing 24 by using a threaded periphery of the end cap that is received by a complimentary threaded portion at the inner circumference housing 24.

Referring to FIGS. 4 and 8, the large cavity of the housing 24 includes a cavity 26 receiving the fuel pump 16. Housing 24 includes an adjoining cavity 32 to the cavity 26, best shown in FIG. 8, for receiving a fuel pick-up 34 extending from the fuel pump 16. An end of the fuel pick-up 34 includes a prefilter or screen 36 for filtering the fuel prior to entering the module 10. An opening 38 (FIGS. 2-4) in the end cap 28 provides access to the top of the fuel pump 16 enabling fuel pump wires 42 and electrical connector 40 (FIG. 3) to extend out of the housing 24.

A cavity 29 adjoins the cavity 32 opposite the cavity 26. The cavities 26, 29, 32 are in fluid communication with one another. A check valve 33 (FIG. 8) is arranged in the housing 24 at the bottom of the cavity 29 for permitting fuel to enter the housing 24 while preventing the fuel from exiting the housing 24. In this manner, the cavities 26, 29, 32 act as a fuel reservoir. The housing 24 also provides a cavity 35 for receiving the filter 18. The cavity 35 is fluidly separated from the cavities 26, 29, 32 by a wall, 37, best shown in FIG. 8.

Referring to FIGS. 2-5, the fuel pump 16 has a conduit providing a fuel pump outlet 44. The fuel pump outlet 44 is received by a portion 48 extending from the bottom surface of the end cap 28 in the embodiment shown. A rubber annular seal 46 is arranged between the fuel pump outlet 44 and portion 48. The filter 18 includes a conduit providing a filter inlet 52 that is received by a portion 50 extending from the bottom surface of the end cap 28. A rubber annular seal 53 is arranged between the portion 50 and filter inlet 52. Similarly, the filter 18 includes a conduit providing a filter outlet 60 that is received in a portion 62 extending from the bottom surface of the end cap 28. A rubber annular seal 64 is arranged between the filter outlet 60 and portion 62.

The portions 48, 50 and 62 and fuel pump outlet 44, filter inlet 52 and filter outlet 60 with their respective seals 46, 53 and 64 enable the fuel pump 16 and filter 18 to be removed from the end cap 28 when the end cap 28 is removed from an installed position to service the components within the module 10. The seals 46, 53 and 64 insure that the fuel flows through the module 10 along a desired path without leaking. Prior art modules relied upon permanently securing housing portions to one another to provide sealed passages, which prevents removal of components for service.

Since the fuel pump outlet 44, and filter inlet 52 and filter outlet 60 are received by the end cap 28, passages must be provided to interconnect them in a desired manner. To this end the end cap 28 includes an upper surface 54 having a recess 56 with a hole 55 in fluid communication with the fuel pump outlet 44 and a hole 57 fluid communication with the filter inlet 52. A cap 58 is secured over the recess 56 to provide fluid communication between the holes 55 and 57. In this manner, fuel flows from the fuel pump outlet 44 to the filter inlet 52 in a sealed manner without leaking.

In a similar manner, the upper surface 54 includes a recess 66 with a hole 67 that is in fluid communication with the filter outlet 60. A cap 68 is secured over the recess 66 to provide fluid communication with both a neck 70 that provides filtered fuel to the engine 14 and a fuel return 72 that returns any unneeded fuel back to the fuel tank 12 at a desired pressure relief set point. As one of ordinary skill will appreciate, using recesses 56, 66 is only one example configuration. The recesses 56, 66 enable the caps 58, 68 to be easily located in their respective desired positions.

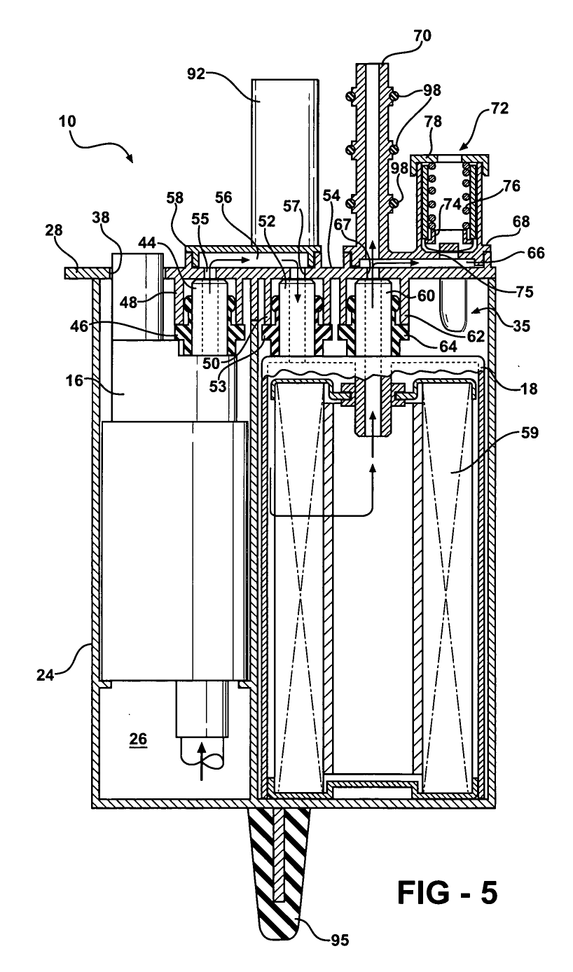

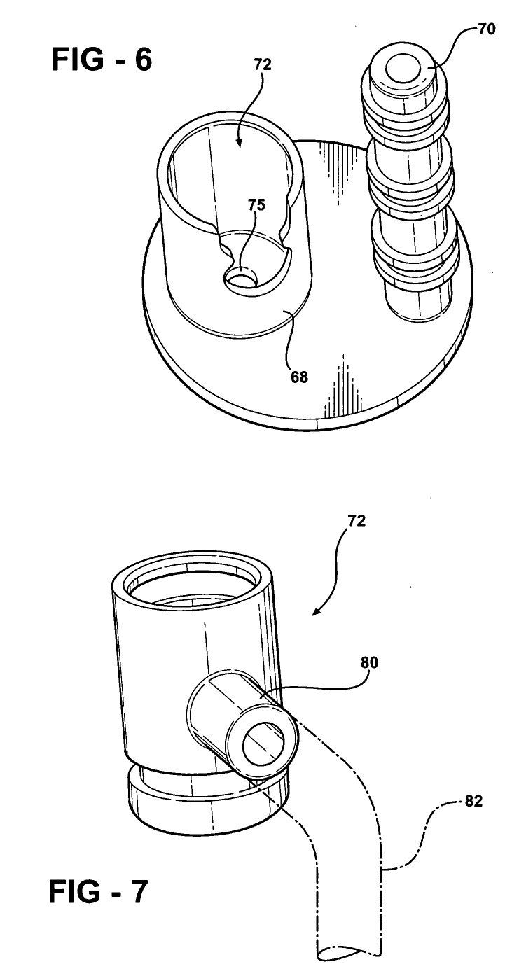

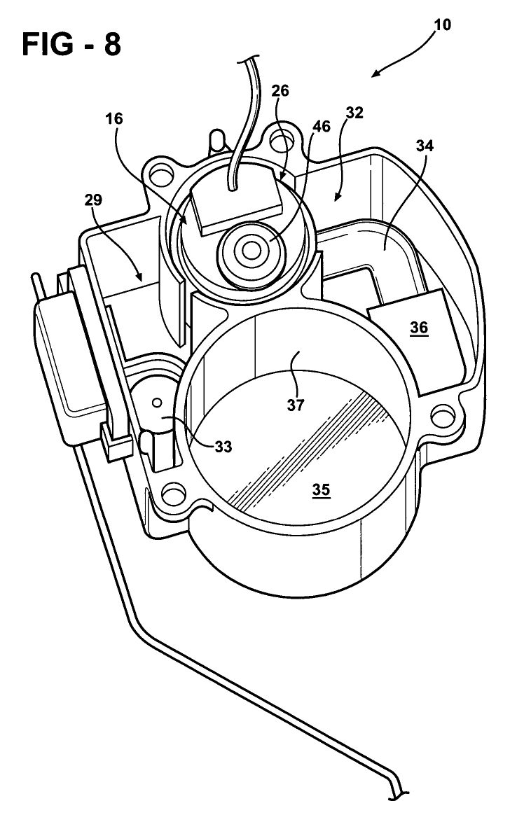

Referring to FIGS. 5-7, the fuel return 72 includes a valve 74 biased to a closed position by a spring 76. The fuel return 72 includes a hole 75 beneath the valve 74 such that when the valve opens the hole 75 is in fluid communication with a return outlet 80. A plate 78 is secured to the fuel return 72 to provide a surface against which the spring 76 may react. A line 82 is connected to the return outlet 80 and may be routed to a desired location within the fuel tank 12. The line 82 may be integrated with the housing 24 or may be a separate fluid line connected to the return outlet 80.

Referring now to FIG. 3-5, a top plate 84 is secured to the fuel tank 12, shown in FIG. 1, when the module 10 is installed. The top plate 84 has an outlet 86 that is fluidly connected to the engine 14. An electrical connection 88 is provided on the top plate so that it is accessible to the exterior of the fuel tank 12. The top plate 84 includes a pair of spaced apart male members 90 (on one is shown in the view of FIG. 3) that are received by female members 92 extending from the end cap 28. Springs 94 are positioned between the male members 90 and the end cap 28 so that the body of the housing 24 is biased toward the bottom of the fuel tank 12. A stop 95 extending from the bottom of the housing 24 locates the fuel pick-up 34 in a desired position relative to the bottom of the fuel tank 12.

The neck 70 includes numerous ridges that locate one or more O-rings 98. The O-rings 98 provide a seal between the neck 70 and a tube 96 extending from the bottom of the top plate 84. It may be desirable for the module 10 to be operable at several vertical lengths so that the module 10 may be used in different fuel tanks having varying depths. Providing multiple O-rings along the length of the neck 70 insures that there is a seal between the neck 70 and the tube 96 at any one of the desired lengths.

The housing 24 includes a side 100 having flanges 102 (FIGS. 2-4) for receiving a base 104 of the fuel level sender 20. The top of the base 104 is retained in the flanges 102 relative to the housing 24 by the end cap 28, which overlies the base 104. As is well known in the art, the fuel level sender 20 includes an arm 108 having a float 110 at one end that is movable based upon the fuel level within the tank 12 and provides an electrical signal through wires 112 and electrical connector 114 indicative of the fuel level within the fuel tank 12.

The electrical connectors 40 and 114 may be secured to the top plate 84 providing electrical connection between the fuel pump 16 and fuel level sender 20 and the electrical connector 88.

In operation, the fuel pump 16 and fuel filter 18 are inserted into the housing 24 to provide the fuel module 10. The fuel module 10 is installed into the fuel tank 12. The fuel module 10 can be opened to gain access to the fuel pump 16 and fuel filter 18 if repair or replacement of those components is desired. In the example shown, the top plate 84 and end cap 28 are removed from the housing body to gain access to the fuel pump 16 and fuel filter 18. The fuel module 10 may be removed from the tank 12, or the fuel module 10 may remain in the tank 12 when servicing the fuel pump 16 and fuel filter 18. In this manner, the entire fuel module 10 need not be discarded when a component within requires service.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A fuel module comprising:
a fuel pump including a fuel inlet and a fuel outlet;
a fuel filter having a filter inlet and a filter outlet; and
a housing including a body defining a cavity, with said fuel pump and said fuel filter arranged in said cavity, said housing including a removable end cap at least partially enclosing said cavity in an installed position and providing access to said cavity in a service position, a fastening element securing said removable end cap to said body in said installed position.

2. The fuel module according to claim 1 wherein said fastening element is a threaded fastener.

3. The fuel module according to claim 1 wherein said housing includes a first portion in fluid connection with said fuel outlet and a second portion in fluid connection with said filter inlet, said housing defining a first passage fluidly connecting said fuel outlet and said filter inlet.

4. The fuel module according to claim 3 wherein said fuel pump comprises a first conduit providing said fuel outlet, said first conduit removably received in said first portion in sealing engagement therewith.

5. The fuel module according to claim 4 wherein a first seal is arranged between said first conduit and said first portion providing a fluid seal therebetween.

6. The fuel module according to claim 3 wherein said fuel filter comprises a second conduit providing said filter inlet, said second conduit removably received in said second portion in sealing engagement therewith.

7. The fuel module according to claim 1 wherein a second seal is arranged between said second conduit and said second portion providing a fluid seal therebetween.

8. The fuel module according to claim 3 wherein said housing includes a surface having first and second holes respectively in fluid communication with said first and second portions, said housing including a first cap secured to said surface enclosing said first and second holes.

9. The fuel module according to claim 3 wherein said housing includes a third portion in fluid connection with said filter outlet, said fuel filter including a third conduit providing said filter outlet, said third conduit removably received in said third portion in sealing engagement therewith.

10. The fuel module according to claim 9 wherein a third seal is arranged between said third conduit and said third portion providing a fluid seal therebetween.

11. The fuel module according to claim 10 said housing includes a surface having a third hole in fluid communication with said third portion, said housing including a second cap secured to said surface enclosing said third hole, said second cap comprising a fourth conduit and a return valve in fluid communication with said third hole.

12. The fuel module according to claim 11 comprising a top plate including a biasing member cooperating with said housing and urging said housing away from said top plate, a neck extending from said plate received by said housing in a sliding relationship with a seal arranged between said neck and said top plate.

13. The fuel module according to claim 1 comprising a fuel level sender secured to said housing.

14. The fuel module according to claim 13 comprising a top plate spaced from and movable relative to said housing, said top plate secured to a fuel tank and having an electrical connector accessible from an exterior of said fuel tank, said fuel level sender and said fuel pump electrically connected to said electrical connector.

15. A fuel module comprising:
a fuel pump including a fuel inlet and a fuel outlet;
a fuel filter having a filter inlet and a filter outlet; and
a housing including a body defining a cavity with said fuel pump and said fuel filter arranged in said cavity, said housing including a surface having a hole in fluid communication with at least one of said fuel pump and said fuel filter, said housing including a cap secured to said surface fluidly connecting said hole to a passage in said housing.

16. The fuel module according to claim 15 wherein said passage is provided by said cap.

17. The fuel module according to claim 15 wherein said passage is provided by a second hole in said surface.

18. A fuel module comprising:
a fuel pump including a fuel inlet and a fuel outlet;
a fuel filter having a filter inlet and a filter outlet;
a housing including a body defining a cavity with said fuel pump and said fuel filter arranged in said cavity; and
first, second and third seals respectively arranged between said housing and said fuel outlet, said filter inlet, and said filter outlet.

19. The fuel module according to claim 18 comprising a removable end cap at least partially enclosing said cavity in an installed position and providing access to said cavity in a service position, said removable end cap having first, second, and third protruding portions respectively receiving said first, said second, and said third seals.

20. A method of using servicing a fuel module comprising the steps of:
a) assembling a fuel pump by mounting a fuel pump and a fuel filter within a fuel module housing;
b) mounting the fuel module into a fuel tank;
c) opening the fuel module housing;
d) removing and replacing at least one of the fuel pump and the fuel filter; and
e) closing the fuel module housing.
